(19) United States
(12) Patent Application Publication
(10) Pub. No.: US 2026/0028506 A1
(43) Pub. Date: Jan. 29, 2026

(54) BIONIC ENVIRONMENT-ADAPTIVE SELF-REPAIRING COATING AS WELL AS PREPARATION METHOD AND USE THEREOF

(71) Applicant: NINGBO INSTITUTE OF MATERIALS TECHNOLOGY AND ENGINEERING, CHINESE ACADEMY OF SCIENCES, Ningbo (CN)

(72) Inventors: Liping WANG, Ningbo (CN); Xiaobo ZHU, Ningbo (CN); Haichao ZHAO, Ningbo (CN); Guangming LU, Ningbo (CN)

(73) Assignee: NINGBO INSTITUTE OF MATERIALS TECHNOLOGY AND ENGINEERING, CHINESE ACADEMY OF SCIENCES, Ningbo (CN)

(21) Appl. No.: 18/267,464

(22) PCT Filed: Sep. 13, 2022
(86) PCT No.: PCT/CN2022/118366

§ 371 Date: Mar. 10, 2025

(30) Foreign Application Priority Data
Aug. 15, 2022 (CN) 202210983932.7

(51) Int. Cl. C09D 175/08; C08G 18/10; C08G 18/38; C08K 9/04; C09D 5/08; C09D 5/36; C09D 7/40; C09D 7/62

(52) U.S. Cl. CPC C09D 175/08; C08G 18/10; C08G 18/3834; C08G 18/3863; C09D 5/084; C09D 5/36; C09D 7/62; C09D 7/70; C08K 9/04; C08K 2201/003; C08K 2201/011

(57) ABSTRACT

A bionic environment-adaptive self-repairing coating as well as a preparation method and use thereof. The preparation method comprises: carrying out condensation polymerization on a first mixed reaction system comprising isocyanate and polyol to obtain a prepolymer; reacting a second mixed reaction system comprising a material containing a non-covalent hydrogen bond and/or a material containing a covalent bisulfide bond and the prepolymer to obtain a polyurethane material; and mixing the polyurethane material with a modified graphene material so that the modified graphene material is distributed in the polyurethane material in a parallel arrangement manner to obtain a composite coating with a nacreous layer structure, and then curing the composite coating to obtain the bionic environment-adaptive self-repairing coating. The bionic environment-adaptive self-repairing coating prepared in the present application has high ultimate tensile strength and excellent mechanical properties.

### CROSS-REFERENCE TO RELATED APPLICATION

This patent application is the national stage entry of International Application No. PCT/CN2022/118366 filed Sep. 13, 2022, and which is based upon and claims the benefit and priority of Chinese Patent Application No. 202210983932.7 filed with the China National Intellectual Property Administration on Aug. 15, 2022, the entire contents of which are incorporated by reference herein.

### TECHNICAL FIELD

The present application relates to a self-repairing coating, particularly to a bionic environment-adaptive self-repairing coating as well as a preparation method and use thereof, belonging to the technical field of self-repairing coatings.

### BACKGROUND

Self-repairing polyurethane is widely applied to the fields of functional coatings, wearable flexible electronic devices, soft robots, electronic skins, artificial muscles and the like because of inherent reprocessing and self-repairing property due to its reversible non-covalent and covalent interactions. However, most of these repairable elastomers need exterior energy to realize healing. At present, the most effective strategy to synthesize a rough self-healing material is to use non-covalent interaction as a sacrificial and reversible cross-linking bond. Unfortunately, these autonomous self-healing materials often exhibit weak mechanical strength (<10 MPa). Therefore, how to solve the conflict between high mechanical properties and self-healing ability of a non-covalent self-healing material is a still huge challenge.

In recent years, researches suggest that multiple dynamic bonds are introduced into autonomous self-repairing elastomers to balance the above problem of preparing the self-repairing composite having excellent comprehensive performance. However, for most of the self-healing elastomers, their low mechanical strength still cannot meet the requirements on a structural material. It is well known that many biological macromolecules in nature exhibit fantastic combinations of conflict mechanical properties based on non-covalent self assembling. For example, unique two-phase structures of spider silks formed by a hydrogen bond array are evenly embedded in an amorphous organic biological matrix, making it become one of the strongest materials in nature. The dynamic breakage and recombination of dense bonds can dissipate a lot of energy so that the material has strong toughness. The “brick-mud” structure of a natural pearl layer is composed of 96 wt % inorganic aragonite and 4 wt % bio-organic polymers, which has excellent breakage toughness. However, the above composites are difficult to obtain excellent tensile property. Therefore, it is of great significance to develop a functional self-repairing coating integrated with high mechanical strength, excellent tensile property and rapid environmental adaptability.

### SUMMARY

The main objective of the present application is to provide a bionic environment-adaptive self-repairing coating and a preparation method thereof, in order to overcome the defects in the prior art.

Another objective of the present application is to provide use of the bionic environment-adaptive self-repairing coating.

To achieve the above-mentioned objectives of the present application, the technical solution adopted by the present application is as follows:

The embodiments of the present application provide a preparation method of a bionic environment-adaptive self-repairing coating, comprising:
carrying out condensation polymerization on a first mixed reaction system comprising isocyanate and polyol to obtain a prepolymer;
reacting a second mixed reaction system comprising a material containing a non-covalent hydrogen bond and/or a material containing a covalent bisulfide bond and the prepolymer to obtain a polyurethane material;
mixing the polyurethane material with a modified graphene material so that the modified graphene material is distributed in the polyurethane material in a parallel arrangement manner to obtain a composite coating with a nacreous layer structure; and
curing the composite coating with the nacreous layer structure to obtain the bionic environment-adaptive self-repairing coating.

The embodiments of the present application also provide a bionic environment-adaptive self-repairing coating, comprising a modified graphene material and a polyurethane material, wherein the modified graphene material is distributed in the polyurethane material in a parallel arrangement manner, and the bionic environment-adaptive self-repairing coating is formed at least by connecting two of a non-covalent hydrogen bond, a covalent bisulfide bond and a graphene interface action bond.

Further, the graphene interface action bond comprises at least any one of an interface non-covalent hydrogen bond and an interface covalent bisulfide bond.

The embodiments of the present application also provide use of the above-mentioned bionic environment-adaptive self-repairing coating in the field of metal corrosion prevention or flexible robot manufacturing.

Compared with the prior art, the present application has the beneficial effects:
1) in the bionic environment-adaptive self-repairing coating provided by the present application, modified graphene can be distributed in polyurethane in a parallel arrangement manner due to the presence of abundant action bonds at the interface, and therefore has high ultimate tensile strength, and excellent mechanical properties due to the presence of abundant non-covalent bonds or covalent bonds;
2) the bionic environment-adaptive self-repairing coating prepared in the present application exhibits super-strong mechanical properties and outstanding self-repairing behavior at room temperature or even under brine water environment due to the synergistic effect of a dynamic hydrogen bond, a flexible disulfide bond and an interface hydrogen bond.

### BRIEF DESCRIPTION OF THE DRAWINGS

To more clearly illustrate the embodiments of the present application or technical solution in the prior art, accompanying drawings required to be used in the embodiments or in the description of the prior art will be simply discussed below. Obviously, the accompanying drawings in the following description are only some embodiments recorded in the present application, and other drawings can be made by persons of ordinary skill in the art without creative efforts according to these drawings.

FIG. 1 is a synthesis route map of polyurethane materials prepared in example 1, comparative example 1 and comparative example 2 of the present application;

FIG. 2 is a cross-section scanning diagram of a bionic environment-adaptive self-repairing coating comprising graphene arranged in parallel in example 1 of the present application;

FIG. 3 is a stress-strain curve diagram of a bionic environment-adaptive self-repairing coating prepared in example 1 of the present application;

FIG. 4 is a surface scanning diagram of a bionic environment-adaptive self-repairing coating prepared in example 1 of the present application after being cut into two sections and being in contact with each other for 24 h at room temperature;

FIG. 5 is a stress-strain curve diagram of a bionic environment-adaptive self-repairing coating prepared in example 1 of the present application after being cut into two sections and contacting for 24 h at room temperature; and

FIG. 6 is a crawling behavior process diagram of a bionic environment-adaptive self-repairing coating prepared in example 1 of the present application under a near-infrared lamp.

### DETAILED DESCRIPTION OF THE EMBODIMENTS

In view of the defects in the prior art, the inventors of this case put forward the technical solution of the present application through long-term researches and lots of practices, which is intended to provide a bionic environment-adaptive self-repairing coating under the enlightenment of natural spider silk and pearl layers and a preparation method thereof. The preparation method mainly comprises the steps of preparing a modified graphene material, preparing a self-repairing polyurethane material, preparing a bionic environment-adaptive self-repairing coating and the like.

Graphene oxide (GO) nanosheets are favored because of their abundant surface oxygen-containing functional groups and excellent mechanical strength. Here, the inventors of the case are inspired by natural spider silks and pearl layers to cooperatively introduce the flexible disulfide bond and the dynamic hexavalent bond into the polyurethane and simultaneously admix a modified graphene nano material into the above polyurethane matrix, so as to introduce high-density action bonds at the interface between them, thereby designing a room-temperature self-repairing polyurethane coating with super-strong mechanical properties and super-high tensile property. The obtained super-molecular composite with an anti-artificial pearl layer structure has greatly improved strength and toughness due to the presence of modified graphene. In addition, multiple acyl semicarbazide, urea and urethane motifs in a main chain of polyurethane are linked to a flexible alicyclic six-atom spacer, which endows the composite with excellent tensile property and toughness, while an aromatic disulfide bond in polyurethane mainly contributes to self-healing performance at room temperature.

Next, this technical solution as well as its implementation process and principle will be further explained.

One aspect of the embodiments of the present application provides a bionic environment-adaptive self-repairing coating under the enlightenment of natural spider silks and pearl layers, which comprises a modified graphene material and a polyurethane material, and is formed by connecting two of a non-covalent hydrogen bond, a covalent bisulfide bond and a graphene interface action bond, wherein the modified graphene material is distribution in the polyurethane material in a parallel arrangement manner due to abundant action bonds at an interface between the modified graphene material and the polyurethane material.

In some embodiments, the bionic environment-adaptive self-repairing coating is formed by connection of multiple action bonds, wherein the multiple action bonds at least comprise two of the non-covalent hydrogen bond, the covalent bisulfide bond and the graphene interface action bond, and the graphene interface action bond at least comprises at least any one of an interface non-covalent hydrogen bond and an interface covalent bisulfide bond.

In some embodiments, the non-covalent hydrogen bond is prepared by introducing adipic acid dihydrazide containing a dynamic hexavalent hydrogen bond into the polyurethane material.

In some embodiments, the covalent bisulfide bond is prepared by introducing 4,4′-diaminodiphenyl disulfide containing a flexible bisulfide bond into the polyurethane material.

In some embodiments, the modified graphene material is prepared from at least one modified graphene oxide of adipic acid dihydrazide containing a dynamic hexavalent hydrogen bond and 4,4′-diaminodiphenyl disulfide containing a flexible bisulfide bond.

In some embodiments, the bionic environment-adaptive self-repairing coating has a rapid environment-adaptive mechanical property self-repairing ability due to energy consumption while breakage, recombination and double decomposition of interior dynamic action bonds.

Another aspect of the embodiments of the present application provides a preparation method of a bionic environment-adaptive self-repairing coating, comprising:
carrying out condensation polymerization on a first mixed reaction system comprising isocyanate and polyol to obtain a prepolymer;
reacting a second mixed reaction system comprising a material containing a non-covalent hydrogen bond and/or a material containing a covalent bisulfide bond and the prepolymer to obtain a polyurethane material;
mixing the polyurethane material with a modified graphene material so that the modified graphene material is distributed in the polyurethane material in a parallel arrangement manner to obtain a composite coating with a nacreous layer structure; and
curing the composite coating with the nacreous layer structure to obtain the bionic environment-adaptive self-repairing coating.

In some embodiments, the preparation method comprises: adding isocyanate into polyol through condensation polymerization to obtain a prepolymer; then introducing a combination of one or two of the non-covalent hydrogen bond and the covalent bisulfide bond into the above prepolymer to obtain a polyurethane material, and finally adding a modified graphene material, wherein due to the presence of abundant action bonds at the interface, the modified graphene material is distributed in the polyurethane material in a parallel arrangement manner, so as to obtain a composite coating with a nacreous layer structure.

In some more specific embodiments, the preparation method comprises: adding polyol into an organic solvent at nitrogen atmosphere, stirring for 20-60 min at 80-130° C. to remove vapor in a system, then adding isocyanate, stirring for 1-6 h at 40-90° C., and then carrying out condensation polymerization to obtain the prepolymer.

Further, a molar ratio of the polyol to the isocyanate is 2:1-1:4.

Further, a mass ratio of the polyol to the organic solvent is 1:1-1:10.

Further, the organic solvent can comprise a combination of any one or more than two of N,N-dimethylformamide, N,N-dimethylacetamide and butyl acetate, but is not limited thereto.

Further, the isocyanate comprises a combination of at least any one or more than two of isophorone diisocyanate (IPDI), hexamethylene diisocyanate (HDI) and 4,4′-dicyclohexyl methane diisocyanate (HMDI), etc., but is not limited thereto.

Further, the polyol comprises a combination of any one or two of polytetrahydrofuran (PTMEG. Mn=250-3000 g/mol), polypropylene glycol (PPG. Mn=400˜3000 g/mol), etc., but is not limited thereto.

In some more specific embodiments, the preparation method comprises: adding a combination of any one or two of adipic dihydrazide and 4,4′-diaminodiphenyl disulfide into the prepolymer, and then stirring for 1-24 h at 20-60° C. to obtain a polyurethane material.

Further, a molar ratio of the combination of any one or two of adipic dihydrazide and 4,4′-diaminodiphenyl disulfide to the polyol is 1:3-3:1.

In some embodiments, the preparation method comprises: adding a modifier containing an action bond into activated a graphene oxide dispersion by a 1-(3-dimethylaminopropyl)-3-ethylcarbodiimide/N-hydroxysuccinimide (EDC/NHS) chemical method, and stirring for more than 6 h at 10-40° C. to obtain a modified graphene material.

Further, the modifier containing the action bond comprises a combination of any one or two of adipic dihydrazide and 4,4′-diaminodiphenyl disulfide, etc., but is not limited thereto.

Further, a mass ratio of the modifier containing the action bond to graphene oxide in the graphene oxide dispersion is 100:1-2000:1.

Further, a mass ratio of EDC to NHS to graphene oxide in the graphene oxide dispersion activated by the EDC/NHS chemical method is 1:1:1-20:20:1.

Further, the graphene oxide dispersion is a graphene oxide dispersion/water dispersion with a concentration of 0.1-10 mg/mL.

Further, the graphene oxide has a diameter of 0.5-20 μm and a thickness of 0.4-4 nm.

In some embodiments, the preparation method comprises: adding a modified graphene material into a polyurethane material to be mixed, so that the modified graphene is distributed in polyurethane in a parallel arrangement manner due to the presence of abundant action bonds at an polyurethane/graphene interface, so as to obtain a composite coating with a nacreous layer structure; and
curing the composite coating to obtain the bionic environment-adaptive self-repairing coating.

Further, the mixing temperature is 20-60° C., and the stirring time is 1-6 h.

In some embodiments, the preparation method comprises: mixing the polyurethane material with the modified graphene material and stirring for 1-6 h at 20-60° C. to obtain a composite coating with a nacreous layer structure, and finally curing the composite coating to obtain the bionic environment-adaptive self-repairing coating.

Further, a mass ratio of the polyurethane material to the modified graphene material is 10:1-1000:1.

Further, the curing temperature is 30-90° C., and the curing time is 12-48 h.

In some embodiments, the preparation method comprises: introducing adipic acid dihydrazide containing a dynamic hexavalent hydrogen bond, 4,4′-diaminodiphenyl disulfide containing a flexible bisulfide bond into a main chain of polyurethane, and finally adding a modified graphene material at least comprising one of a non-covalent hydrogen bond and a covalent bisulfide bond.

In some more specific embodiments, the preparation method comprises:
adding polyurethane into polyol through condensation polymerization to obtain a prepolymer; then introducing a combination of one or two of the non-covalent hydrogen bond and the covalent bisulfide bond into the above prepolymer to obtain a polyurethane material, and finally adding a modified graphene material, wherein the modified graphene is distributed in polyurethane in a parallel arrangement manner due to the presence of abundant action bonds at the interface, so as to obtain a composite coating with a nacreous layer structure.

In some more typical specific embodiments, the preparation method of the bionic environment-adaptive self-repairing coating of the present application comprises the following steps:
1) modification of graphene: adding a modifier containing an action bond into a graphene oxide dispersion activated by an EDC/NHS chemical method in a mass ratio of 100:1-2000:1 and stirring for more than 6 h at 10-40° C.;
2) preparation of self-repairing polyurethane material: adding polyol into an organic solvent at nitrogen atmosphere through condensation polymerization, stirring for 20-60 min at 80-130° C. to remove vapor in a system, then adding isocyanate, stirring for 1-6 h at 40-90° C., and then carrying out condensation polymerization to obtain the prepolymer; and adding a combination of one or two of adipic dihydrazide and 4,4′-diaminodiphenyl disulfide into the prepolymer, and then stirring for 1-24 h at 20-60° C. to obtain a polyurethane material;
3) preparation of bionic environment-adaptive self-repairing coating: mixing the polyurethane material with the modified graphene material in a mass ratio of 10:1-1000:1, stirring for 1-6 h at 20-60° C. to obtain a composite coating with a nacreous layer structure, and finally curing the composite coating to obtain the bionic environment-adaptive self-repairing coating; wherein, the curing temperature is 30-90° C., and the curing time is 12-48 h.

Another aspect of the embodiments of the present application further provides the bionic environment-adaptive self-repairing coating prepared by the above-mentioned preparation method, wherein the modified graphene material is distributed in the polyurethane material in a parallel arrangement manner due to the presence of abundant action bonds (interface hydrogen bond) at the interface between the modified graphene material and the polyurethane material.

In some embodiments, the bionic environment-adaptive self-repairing coating has an adjustable high ultimate tensile strength of 5-90 MPa and an adjustable elongation of 900-1400% due to the presence of graphene arranged in parallel.

Further, the bionic environment-adaptive self-repairing coating provided in the present application has excellent mechanical properties due to the presence of abundant non-covalent bonds or covalent bonds.

In some preferred embodiments, the bionic environment-adaptive self-repairing coating has a rapid environment-adaptive mechanical property self-repairing ability due to energy consumption while breakage, recombination and double decomposition of interior dynamic action bonds. Where, the environment comprises a combination of at least any one or more than two of a low-temperature environment, a room-temperature environment, a high-temperature environment and a brine environment.

Further, after the bionic environment-adaptive self-repairing coating is cut into two sections and in contact with each other for 2-36 h, 80%-92% of its ultimate tensile strength can be recovered.

In summary, the bionic environment-adaptive self-repairing coating prepared in the present application shows super-strong mechanical properties and outstanding self-repairing behavior at room temperature or even in a brine environment due to a synergistic effect among a dynamic hydrogen bond, a flexible bisulfide bond and an interface hydrogen bond.

Another aspect of the embodiments of the present application further provides use of the bionic environment-adaptive self-repairing coating in the field of metal corrosion prevention or flexible robot manufacturing.

To sum up, in the present application, the bionic environmental adaptive self-repairing coating can be prepared by cooperative combination of at least two of the non-covalent hydrogen bond, the covalent disulfide bond and the graphene interface interaction bond. Where, the modified graphene can be distributed in polyurethane in a parallel arrangement manner due to the presence of abundant action bonds at the interface. The bionic environmental adaptive self-repairing coating has high ultimate tensile strength due to the presence of graphene arranged in parallel, and also has excellent mechanical properties due to the presence of abundant non-covalent bonds or covalent bonds. With the help of energy consumption while the breakage, recombination and decomposition of interior dynamic action bonds, the bionic environmental adaptive self-repairing coating also shows a rapid environmental adaptive mechanical property self-repairing ability; specifically, the bionic environment-adaptive self-repairing coating has an adjustable ultimate tensile strength of 5-90 MPa and an adjustable elongation of 900-1400% adjustable; furthermore, after the bionic environmental adaptive self-repairing coating is cut into two sections and then in contact with each other for 2-36 h, 80-92% of its ultimate tensile strength can be recovered, which successfully solves the conflict between high mechanical properties and rapid room-temperature self-repairing ability of the self-repairing material.

Next, the technical solutions in embodiments of the present application will be clearly and completely described in combination with specific embodiments and drawings. Obviously, the described examples are only some embodiments of the present application but not all the embodiments. Based on the embodiments of the present application, other embodiments made by persons of ordinary skill in the art without creative efforts are all included within the protective scope of the present application.

### Example 1

A preparation method of a bionic environment-adaptive self-repairing coating comprises the following steps:
1. Modification of graphene: a modifier adipic dihydrazide containing a non-covalent hydrogen bond was added into a 1 mg/mL graphene oxide dispersion activated by an EDC/NHS chemical method in a mass ratio of 1000:1 and then the above materials were stirred for 24 h at 25° C., wherein a mass ratio of EDC: NHS: graphene oxide was 5:15:1.
2. Preparation of self-repairing polyurethane material: 20 g of PTMEG-2000 (10 mM) was added into 150 mL of N,N-dimethylacetamide at nitrogen atmosphere through condensation polymerization, then the above materials were stirred for 30 min at 110° C. to remove vapor in a system, then 5.26 g of hexamethylene dissocyanate (HMDI) (20 mM) was added, and the above materials were stirred for 3 h at 80° C. to obtain a prepolymer; 1.31 g of adipic dihydrazide (7.5 mM) and 0.62 g of 4,4′-diaminodiphenyl disulfide (2.5 mM) were added into the prepolymer, and then the above materials were stirred for 12 h at 40° C. to obtain the polyurethane material, wherein mM=10⁻³ mol.
3. Preparation of bionic environment-adaptive self-repairing coating: the polyurethane material was mixed with the modified graphene material in a mass ratio of 200:1, the obtained mixture was stirred for 3 h at 40° C. to obtain a composite coating with a nacreous layer structure, and finally the composite coating was cured for 24 h at 80° C. to obtain the bionic environment-adaptive self-repairing coating.

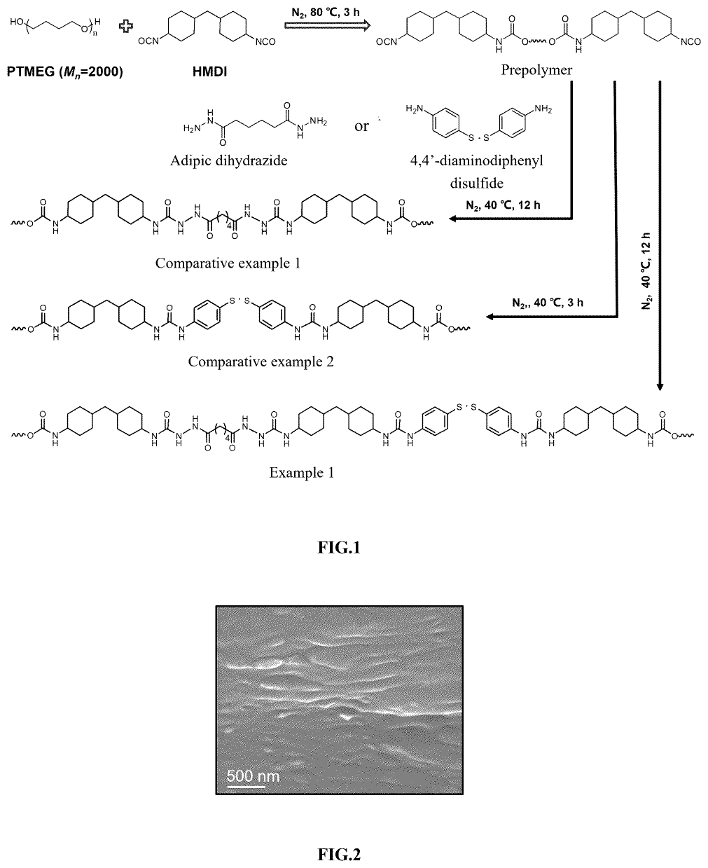

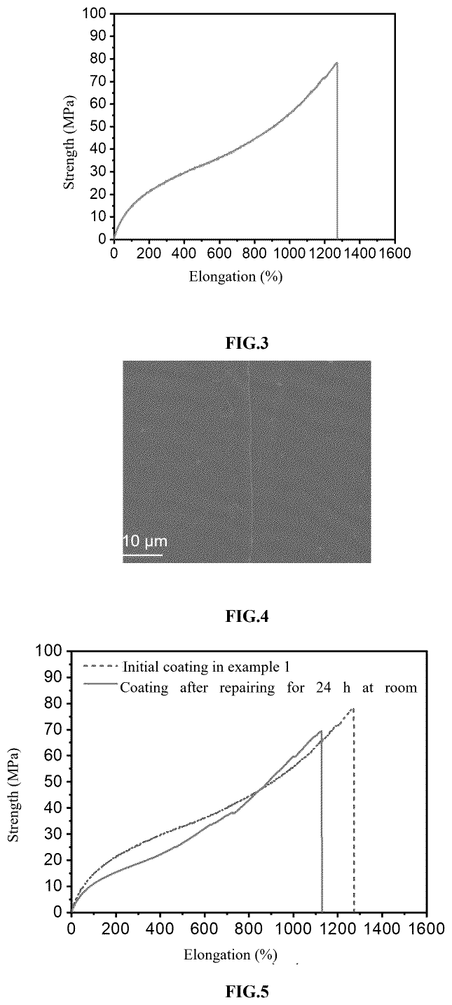

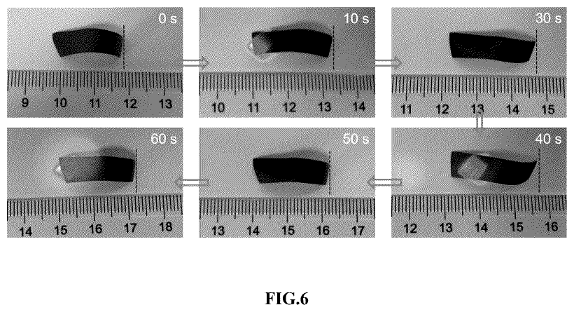

FIG. 1 is a synthesis route map of the polyurethane material in example 1, and the cross-sectional scanning diagram of the bionic environment-adaptive self-repairing coating is as shown in FIG. 2. Obviously, the modified graphene material is arranged in polyurethane in parallel, which is conducive to improving the ultimate tensile strength of the composite. Meanwhile, the composite has excellent mechanical properties due to the presence of abundant dynamic hexavalent hydrogen bonds at the polyurethane/graphene interface. The stress-strain curve of the composite in this example is as shown in FIG. 3, and the ultimate tensile strength and elongation of the composite are respectively up to 78.3 Mpa and 1273.2%, showing excellent mechanical properties. In addition, since abundant dynamic hexavalent hydrogen bonds are present in the polyurethane material in this example, as well as the composite has a rapid room-temperature mechanical property self-repairing ability due to energy consumption while breakage, recombination and double decomposition of abundant hydrogen bonds at the polyurethane/graphene interface. After the composite is cut into two sections and then in contact with each other for 24 h at room temperature, 88.6% of its ultimate tensile strength can be recovered. The surface scanning diagram and stress-strain curve diagram of the composite subjected to self healing are respectively as shown in FIG. 4 and FIG. 5. In addition, the bionic environment-adaptive self-repairing coating in this example can realize autonomous healing at low temperature and in 3.5 wt % brine, showing an excellent environment-adaptive repairing ability. By virtue of the difference between thermal expansion coefficients of the bionic environment-adaptive self-repairing coating and the modified graphene material in this example, the inventors of this case assemble a crawling robot which can show a crawling behavior under the driving of a near infrared lamp, and its optic process is as shown in FIG. 6. Therefore, the bionic environment-adaptive self-repairing coating prepared in this example has wide application prospects in the fields of metal corrosion prevention, flexible robots and the like.

### Example 2

A preparation method of a bionic environment-adaptive self-repairing coating comprises the following steps:
1. Modification of graphene: a modifier 4,4′-diaminodiphenyl disulfide containing a covalent bisulfide bond was added into a 0.1 mg/mL graphene oxide dispersion activated by an EDC/NHS chemical method in a mass ratio of 100:1 and then the above materials were stirred for 48 h at 10° C., wherein a mass ratio of EDC:NHS:graphene oxide was 1:1:1.
2. Preparation of self-repairing polyurethane material: 40.0 g of PPG-400 (100 mM) was added into 25 mL of butyl acetate at nitrogen atmosphere through condensation polymerization, then the above materials were stirred for 60 min at 80° C. to remove vapor in a system, then 11.1 g of isophorone diisocyanate (IPDI) (50 mM) was added, and the above materials were stirred for 6 h at 40° C. to obtain a prepolymer; 8.27 g of 4,4′-diaminodiphenyl disulfide (33 mM) was added into the prepolymer, and then the above materials were stirred for 24 h at 20° C. to obtain the polyurethane material, wherein mM=10⁻³ mol.
3. Preparation of bionic environment-adaptive self-repairing coating: the polyurethane material was mixed with the modified graphene material in a mass ratio of 1000:1, the obtained mixture was stirred for 6 h at 20° C. to obtain a composite coating with a nacreous layer structure, and finally the composite coating was cured for 48 h at 30° C. to obtain the bionic environment-adaptive self-repairing coating.

### Example 3

A preparation method of a bionic environment-adaptive self-repairing coating comprises the following steps:
1. Modification of graphene: a modifier adipic dihydrazide containing a non-covalent hydrogen bond was added into a 10 mg/mL graphene oxide dispersion activated by an EDC/NHS chemical method in a mass ratio of 2000:1 and then the above materials were stirred for 6 h at 40° C., wherein a mass ratio of EDC:NHS:graphene oxide was 20:20:1.
2. Preparation of self-repairing polyurethane material: 25 g of PTMEG-250 (100 mM) was added into 200 mL of N,N-dimethylformamide at nitrogen atmosphere through condensation polymerization, then the above materials were stirred for 20 min at 130° C. to remove vapor in a system, then 67.28 g of HDI (400 mM) was added, and the above materials were stirred for 1 h at 90° C. to obtain a prepolymer; 52.41 g of adipic dihydrazide (300 mM) was added into the prepolymer, and then the above materials were stirred for 1 h at 60° C. to obtain the polyurethane material, wherein mM=10⁻³ mol.
3. Preparation of bionic environment-adaptive self-repairing coating: the polyurethane material was mixed with the modified graphene material in a mass ratio of 10:1, the obtained mixture was stirred for 1 h at 60° C. to obtain a composite coating with a nacreous layer structure, and finally the composite coating was cured for 12 h at 90° C. to obtain the bionic environment-adaptive self-repairing coating.

### Example 4

A preparation method of a bionic environment-adaptive self-repairing coating comprises the following steps:
1. Modification of graphene: a modifier adipic dihydrazide containing a non-covalent hydrogen bond and a modifier 4,4′-diaminodiphenyl disulfide containing a covalent bisulfide bond were added into a 5 mg/mL graphene oxide dispersion activated by an EDC/NHS chemical method in a mass ratio of 500:1 and then the above materials were stirred for 18 h at 30° C., wherein a mass ratio of EDC:NHS:graphene oxide was 10:10:1, and a molar ratio of adipic dihydrazide to 4,4′-diaminodiphenyl disulfide was 1:1.
2. Preparation of self-repairing polyurethane material: 20.0 g of PPG-2000 (10 mM) was added into 50 mL of N,N-dimethylformamide at nitrogen atmosphere through condensation polymerization, then the above materials were stirred for 40 min at 100° C. to remove vapor in a system, then 1.68 g of HDI (10 mM) was added, and the above materials were stirred for 4 h at 70° C. to obtain a prepolymer; 0.87 g of adipic dihydrazide (5 mM) and 1.24 g of 4,4′-diaminodiphenyl disulfide were added into the prepolymer, and then the above materials were stirred for 16 h at 50° C. to obtain the polyurethane material, wherein mM=10⁻³ mol.
3. Preparation of bionic environment-adaptive self-repairing coating: the polyurethane material was mixed with the modified graphene material in a mass ratio of 50:1, the obtained mixture was stirred for 2 h at 50° C. to obtain a composite coating with a nacreous layer structure, and finally the composite coating was cured for 40 h at 70° C. to obtain the bionic environment-adaptive self-repairing coating.

### Example 5

A preparation method of a bionic environment-adaptive self-repairing coating comprises the following steps:
1. Modification of graphene: a modifier adipic dihydrazide containing a non-covalent hydrogen bond was added into a 2 mg/mL graphene oxide dispersion activated by an EDC/NHS chemical method in a mass ratio of 500:1 and then the above materials were stirred for 20 h at 28° C., wherein a mass ratio of EDC:NHS:graphene oxide was 1:3:1.
2. Preparation of self-repairing polyurethane material: 30 g of PTMEG-3000 (10 mM) was added into 120 mL of N,N-dimethylacetamide at nitrogen atmosphere through condensation polymerization, then the above materials were stirred for 40 min at 90° C. to remove vapor in a system, then 5.26 g of HMDI (20 mM) was added, and the above materials were stirred for 5 h at 50° C. to obtain a prepolymer; 0.44 g of adipic dihydrazide (2.5 mM) and 1.86 g of 4,4′-diaminodiphenyl disulfide (7.5 mM) were added into the prepolymer and then the above materials were stirred for 4 h at 50° C. to obtain the polyurethane material, wherein mM=10⁻³ mol.
3. Preparation of bionic environment-adaptive self-repairing coating: the polyurethane material was mixed with the modified graphene material in a mass ratio of 500:1, the obtained mixture was stirred for 2 h at 50° C. to obtain a composite coating with a nacreous layer structure, and finally the composite coating was cured for 42 h at 50° C. to obtain the bionic environment-adaptive self-repairing coating.

### Example 6

A preparation method of a bionic environment-adaptive self-repairing coating comprises the following steps:
1. Modification of graphene: a modifier 4,4′-diaminodiphenyl disulfide containing a covalent bisulfide bond was added into a 0.2 mg/mL graphene oxide dispersion activated by an EDC/NHS chemical method in a mass ratio of 200:1 and then the above materials were stirred for 36 h at 20° C., wherein a mass ratio of EDC:NHS:graphene oxide was 10:20:1.
2. Preparation of self-repairing polyurethane material: 10 g of PTMEG-1000 (10 mM) was added into 120 mL of ethyl acetate at nitrogen atmosphere through condensation polymerization, then the above materials were stirred for 40 min at 90° C. to remove vapor in a system, then 7.89 g of HMDI (30 mM) was added, and the above materials were stirred for 4.5 h at 60° C. to obtain a prepolymer; 2.64 g of adipic dihydrazide (15 mM) and 1.24 g of 4,4′-diaminodiphenyl disulfide were added into the prepolymer and then the above materials were stirred for 18 h at 30° C. to obtain the polyurethane material, wherein mM=10⁻³ mol.
3. Preparation of bionic environment-adaptive self-repairing coating: the polyurethane material was mixed with the modified graphene material in a mass ratio of 100:1, the obtained mixture was stirred for 4 h at 30° C. to obtain a composite coating with a nacreous layer structure, and finally the composite coating was cured for 45 h at 40° C. to obtain the bionic environment-adaptive self-repairing coating.

### Example 7

A preparation method of a bionic environment-adaptive self-repairing coating comprises the following steps:
1. Modification of graphene: a modifier adipic dihydrazide containing a non-covalent hydrogen bond and a modifier 4,4′-diaminodiphenyl disulfide containing a covalent bisulfide bond were added into a 4 mg/mL graphene oxide dispersion activated by an EDC/NHS chemical method in a mass ratio of 300:1 and then the above materials were stirred for 24 h at 25° C., wherein a mass ratio of EDC:NHS:graphene oxide was 20:20:1, and a molar ratio of adipic dihydrazide to 4,4′-diaminodiphenyl disulfide was 2:1.
2. Preparation of self-repairing polyurethane material: 42 g of PTMEG-1400 (30 mM) was added into 100 mL of N,N-dimethylformamide at nitrogen atmosphere through condensation polymerization, then the above materials were stirred for 25 min at 120° C. to remove vapor in a system, then 3.36 g of HDI (20 mM) was added, and the above materials were stirred for 4 h at 70° C. to obtain a prepolymer; 2.64 g of adipic dihydrazide (15 mM) was added into the prepolymer and then the above materials were stirred for 12 h at 40° C. to obtain the polyurethane material, wherein mM=10⁻³ mol.
3. Preparation of bionic environment-adaptive self-repairing coating: the polyurethane material was mixed with the modified graphene material in a mass ratio of 400:1, the obtained mixture was stirred for 3 h at 40° C. to obtain a composite coating with a nacreous layer structure, and finally the composite coating was cured for 44 h at 60° C. to obtain the bionic environment-adaptive self-repairing coating.

### Example 8

A preparation method of a bionic environment-adaptive self-repairing coating comprises the following steps:
1. Modification of graphene: a modifier adipic dihydrazide containing a non-covalent hydrogen bond and a modifier 4,4′-diaminodiphenyl disulfide containing a covalent bisulfide bond were added into a 8 mg/mL graphene oxide dispersion activated by an EDC/NHS chemical method in a mass ratio of 1500:1 and then the above materials were stirred for 12 h at 35° C., wherein a mass ratio of EDC:NHS:graphene oxide was 15:5:1, and a molar ratio of adipic dihydrazide to 4,4′-diaminodiphenyl disulfide was 1:2.
2. Preparation of self-repairing polyurethane material: 30 g of PPG-3000 (10 mM) was added into 120 mL of N,N-dimethylformamide at nitrogen atmosphere through condensation polymerization, then the above materials were stirred for 40 min at 100° C. to remove vapor in a system, then 4.44 g of IPDI (20 mM) was added, and the above materials were stirred for 3 h at 80° C. to obtain a prepolymer; 2.48 g of 4,4′-diaminodiphenyl disulfide was added into the prepolymer and then the above materials were stirred for 4 h at 50° C. to obtain the polyurethane material, wherein mM=10⁻³ mol.
3. Preparation of bionic environment-adaptive self-repairing coating: the polyurethane material was mixed with the modified graphene material in a mass ratio of 800:1, the obtained mixture was stirred for 5 h at 25° C. to obtain a composite coating with a nacreous layer structure, and finally the composite coating was cured for 24 h at 80° C. to obtain the bionic environment-adaptive self-repairing coating.

### Example 9

This example is basically the same as example 2 except that the step 2 is replaced as:

20.0 g of PPG-400 (200 mM) was added into 25 mL of butyl acetate at nitrogen atmosphere through condensation polymerization, then the above materials were stirred for 60 min at 80° C. to remove vapor in a system, then 22.2 g of IPDI (100 mM) was added, and the above materials were stirred for 6 h at 40° C. to obtain a prepolymer; 24.8 g of 4,4′-diaminodiphenyl disulfide (100 mM) was added into the prepolymer and then the above materials were stirred for 24 h at 20° C. to obtain the polyurethane material, wherein mM=10⁻³ mol.

### Example 10

This example is basically the same as example 2 except that the step 3 is replaced as:

25 g of PTMEG-250 (100 mM) was added into 200 mL of N,N-dimethylformamide at nitrogen atmosphere through condensation polymerization and then the above materials were stirred for 20 min at 130° C. to remove vapor in a system, then 16.82 g of HDI (100 mM) was added, and the above materials were stirred for 1 h at 90° C. to obtain a prepolymer; 17.47 g of adipic dihydrazide (100 mM) was added into the prepolymer and then the above materials were stirred for 1 h at 60° C. to obtain the polyurethane material, wherein mM=10⁻³ mol.

### Comparative Example 1

A preparation method of a coating comprises the following steps:

10 g of PTMEG-2000 (5 mM) was added into 20 mL of N,N-dimethylformamide at nitrogen atmosphere through condensation polymerization and then the above materials were stirred for 30 min at 110° C. to remove vapor in a system, then 2.63 g of HMDI (10 mM) was added, and the above materials were stirred for 3 h at 80° C. to obtain a prepolymer; 0.87 g of adipic dihydrazide (5 mM) was added into the prepolymer and then the above materials were stirred for 12 h at 40° C. to obtain the polyurethane material, wherein mM=10⁻³ mol.

The coating was prepared by using the polyurethane material.

### Comparative Example 2

20 g of PTMEG-2000 (10 mM) was added into 20 mL of N,N-dimethylformamide at nitrogen atmosphere through condensation polymerization and then the above materials were stirred for 30 min at 110° C. to remove vapor in a system, then 5.26 g of HMDI (20 mM) was added, and the above materials were stirred for 3 h at 80° C. to obtain a prepolymer; 2.48 g of 4,4′-diaminodiphenyl disulfide (10 mM) was added into the prepolymer and then the above materials were stirred for 3 h at 40° C. to obtain the polyurethane material, wherein mM=10⁻³ mol.

The coating was prepared by using the polyurethane material.

The mechanical properties and self-repairing behaviors of the bionic environment-adaptive self-repairing coating prepared in example 1 and the coatings prepared in comparative example 1 and comparative example 2 are as follows:

| | Ultimate tensile | Elongation at | | Young's | | Repairing |
|---|---|---|---|---|---|---|
| | strength | break | Toughness | modulus | Repairing | efficiency |
| Sample | (MPa) | (%) | (MJ m⁻³) | (MPa) | conditions | (%) |
| Example 1 | 78.3 ± 1.8 | 1273.2 ± 12.4 | 505.7 ± 5.6 | 81.8 ± 1.8 | Room | 88.6 ± 0.7 |
| | | | | | temperature, | |
| | | | | | 2 h | |
| Comparative | 67.7 ± 1.4 | 1093.8 ± 13.8 | 292.1 ± 4.2 | 76.7 ± 1.6 | 80° C., 2 h | 90.4 ± 0.8 |
| example 1 | | | | | Room | 4.2 ± 0.2 |
| | | | | | temperature, | |
| | | | | | 2 h | |
| Comparative | 7.13 ± 0.6 | 903.2 ± 11.4 | 48.0 ± 1.1 | 14.5 ± 0.6 | Room | 91.2 ± 0.6 |
| example 2 | | | | | temperature, | |
| | | | | | 2 h | |

Note:
the repairing efficiency in Table is a ratio of the ultimate tensile strength after the sample is repaired to initial ultimate tensile strength.

The repairing conditions in comparative example 1 are different from those in example 1 in that repairing can be conducted only under the condition of heating, almost no repairing effect occurs at room temperature, and the mechanical properties in comparative example 2 are poor.

### Comparative Example 3

This comparative example is different from example 1 in that unmodified graphene oxide is used in step 1.

The finally obtained coating has ultimate tensile strength of 66.4±2.1 MPa, an elongation at break of 1180.3±11.8%, toughness of 322.4±3.7MJ m⁻³, Young's modulus of 60.4±2.3 MPa, and the repairing efficiency of 12.4±0.4% after 24 h at room temperature.

To sum up, the bionic environment-adaptive self-repairing coating is prepared through cooperative combination of at least two of the non-covalent hydrogen bond, the covalent bisulfide bond and the graphene interface action bond. Where, the modified graphene can be distributed in polyurethane in a parallel arrangement manner due to the presence of abundant action bonds at the interface. The bionic environment-adaptive self-repairing coating has high ultimate tensile strength due to the presence of graphene arranged in parallel and meanwhile has excellent mechanical properties due to the presence of abundant non-covalent bonds to covalent bonds. By virtue of energy consumption while breakage, recombination and double decomposition of interior dynamic action bonds, the bionic environment-adaptive self-repairing coating also exhibits the rapid environment-adaptive mechanical property self-repairing ability; specifically, the bionic environment-adaptive self-repairing coating has adjustable ultimate tensile strength of 5-90 MPa and adjustable elongation of 900-1400%; furthermore, after the bionic environment-adaptive self-repairing coating is cut into two sections and in contact with each other for 2-36 h, 80-92% of its ultimate tensile strength can be recovered, which successfully solves the conflict between high mechanical properties and rapid room-temperature self-repairing ability in the self-repairing material.

All aspects, embodiments, features and examples of the present application shall be regarded as illustrative in all aspects and are not intended to limit the present application. The scope of the present application is only defined by the claims. Without departing from the spirit and scope of the present application, those skilled in the art will understand other embodiments, modifications and uses.

In addition, the inventors of this case also conducted experiments with other raw materials, process operation and process conditions described in this manual with reference to the aforementioned embodiments, and obtained relatively ideal results.

Although the present application has been described with reference to the illustrative embodiments, those skilled in the art will understand that various other changes, omissions and/or additions can be made without departing from the spirit and scope of the present application, and the elements of the embodiments can be replaced by substantial equivalents. In addition, many modifications can be made without departing from the scope of the present application to adapt specific situations or materials to the teaching of the present application. Therefore, this document does not intend to limit the application to the specific embodiments disclosed for the implementation of the present application, but rather to make the present application include all embodiments within the scope of the appended claims. In addition, unless specifically stated, any use of the terms first, second and the like does not indicate any order or importance, but the terms first, second and the like are used to distinguish one element from another element.

What is claimed is:

1. A preparation method of a bionic environment-adaptive self-repairing coating, comprising:
carrying out condensation polymerization on a first mixed reaction system comprising isocyanate and polyol to obtain a prepolymer;
reacting a second mixed reaction system comprising a material containing a non-covalent hydrogen bond and/or a material containing a covalent bisulfide bond and the prepolymer to obtain a polyurethane material;
mixing the polyurethane material with a modified graphene material so that the modified graphene material is distributed in the polyurethane material in a parallel arrangement manner to obtain a composite coating with a nacreous layer structure; and
curing the composite coating with the nacreous layer structure to obtain the bionic environment-adaptive self-repairing coating.

2. The preparation method according to claim 1, wherein the step of carrying out condensation polymerization on the first mixed reaction system comprises: adding the polyol into an organic solvent, stirring for 20-60 min at 80-130° C., then adding the isocyanate, stirring for 1-6 h at 40-90° C., and then carrying out condensation polymerization to obtain the prepolymer.

3. The preparation method according to claim 2, wherein a molar ratio of the polyol to the isocyanate is 2:1-1:4; and/or a mass ratio of the polyol to the organic solvent is 1:1-1:10; and/or the organic solvent comprises a combination of any one or more than two of N,N-dimethylformamide, N,N-dimethylacetamide and butyl acetate;
and/or the isocyanate comprises one or more of isophorone diisocyanate, hexamethylene diisocyanate and 4,4′-dicyclohexyl methane diisocyanate;
and/or the polyol comprises polytetrahydrofuran and/or polypropylene glycol.

4. The preparation method according to claim 1, wherein the step of reacting the second mixed reaction system comprises: adding any one of adipic dihydrazide and 4,4′-diaminodiphenyl disulfide into the prepolymer, and then stirring for 1-24 h at 20-60° C. to obtain a polyurethane material.

5. The preparation method according to claim 4, wherein a molar ratio of the adipic dihydrazide and/or 4,4′-diaminodiphenyl disulfide to the polyol is 1:3-3:1.

6. The preparation method according to claim 1, wherein the step of mixing the polyurethane with the modified graphene material comprises: adding a modifier containing an action bond into a graphene oxide dispersion activated by 1-(3-dimethylaminopropyl)-3-ethylcarbodiimide/N-hydroxysuccinimide (EDC/NHS) activation, and stirring for more than 6 h at 10-40° C. to obtain a modified graphene material; wherein the modifier containing the action bond comprises adipic dihydrazide and/or 4,4′-diaminodiphenyl disulfide.

7. The preparation method according to claim 6, wherein a mass ratio of the modifier containing the action bond to graphene oxide in the graphene oxide dispersion is 100:1-2000:1;
and/or a mass ratio of EDC to NHS to graphene oxide in the graphene oxide dispersion activated by the EDC/NHS chemical method is 1:1:1-20:20:1;
and/or the graphene oxide dispersion is a graphene oxide dispersion/water dispersion with a concentration of 0.1-10 mg/mL.

8. The preparation method according to claim 7, wherein the graphene oxide has a diameter of 0.5-20 μm and a thickness of 0.4-4 nm.

9. The preparation method according to claim 1, wherein the step of mixing the polyurethane with the modified graphene material comprises: mixing the polyurethane material with the modified graphene material and stirring for 1-6 h at 20-60° C. to obtain the composite coating with a nacreous layer structure, and finally curing the composite coating to obtain the bionic environment-adaptive self-repairing coating.

10. The preparation method according to claim 1, wherein a mass ratio of the polyurethane material to the modified graphene material is 10:1-1000:1.

11. The preparation method according to claim 1, wherein the curing temperature is 30-90° C., and the curing time is 12-48 h.

12. The bionic environment-adaptive self-repairing coating prepared by the preparation method according to claim 1, wherein the bionic environment-adaptive self-repairing coating comprises a modified graphene material and a polyurethane material, the modified graphene material is distributed in the polyurethane material in a parallel arrangement manner, and the bionic environment-adaptive self-repairing coating is formed at least by connecting two of a non-covalent hydrogen bond, a covalent bisulfide bond and a graphene interface action bond.

13. The bionic environment-adaptive self-repairing coating according to claim 12, wherein the graphene interface action bond comprises a non-covalent hydrogen bond and/or an interface covalent bisulfide bond.

14. The bionic environment-adaptive self-repairing coating according to claim 12, wherein the non-covalent hydrogen bond is prepared by introducing adipic acid dihydrazide containing a dynamic hexavalent hydrogen bond into the polyurethane material;
and/or the covalent bisulfide bond is prepared by introducing 4,4′-diaminodiphenyl disulfide containing a flexible bisulfide bond into the polyurethane material;
and/or the modified graphene material is prepared from at least one modified graphene of adipic acid dihydrazide containing a dynamic hexavalent hydrogen bond and 4,4′-diaminodiphenyl disulfide containing a flexible bisulfide bond;
and/or the bionic environment-adaptive self-repairing coating has an ultimate tensile strength of 5-90 MPa and an elongation of 900-1400%;
and/or the environment-adaptive bionic self-repairing coating has an environment-adaptive mechanical property self-repairing ability, wherein the environment comprises at least any one of a low-temperature environment, a room-temperature environment, a high-temperature environment and a brine environment; the mechanical property self-repairing ability is to recover 80%-92% of ultimate tensile strength after 2-36 h.

15. Use of the bionic environment-adaptive self-repairing coating according to claim 12 in the fields of metal corrosion prevention or flexible robot manufacturing.

16. Use of the bionic environment-adaptive self-repairing coating according to claim 13 in the fields of metal corrosion prevention or flexible robot manufacturing.

17. Use of the bionic environment-adaptive self-repairing coating according to claim 14 in the fields of metal corrosion prevention or flexible robot manufacturing.
